(19) United States
(12) Patent Application Publication
(10) Pub. No.: US 2015/0085914 A1
(43) Pub. Date: Mar. 26, 2015

(54) Modal PAM2/4 Pipelined Programmable Receiver Having Feed Forward Equalizer (FFE) And Decision Feedback Equalizer (DFE) Optimized For Forward Error Correction (FEC) Bit Error Rate (BER) Performance

(71) Applicant: Avago Technologies General IP (Singapore) Pte. Ltd., Singapore (SG)

(72) Inventors: Jade Michael Kizer, Windsor, CO (US); Jeffrey A. Slavick, Fort Collins, CO (US); Ronald R. Kennedy, Fort Collins, CO (US); Peter J. Meier, Fort Collins, CO (US)

(73) Assignee: Avago Technologies General IP (Singapore) Pte. Ltd., Singapore (SG)

(21) Appl. No.: 14/036,043

(22) Filed: Sep. 25, 2013

(51) Int. Cl. H04L 25/03

(52) U.S. Cl. CPC H04L 25/03885
USPC 375/233

(57) ABSTRACT

A pipelined receiver comprises a programmable feed forward equalizer (FFE), a programmable decision feedback equalizer (DFE), and logic for controlling a ratio of FFE and DFE to apply to a received signal based on at least one channel parameter.

### BACKGROUND

A modern integrated circuit (IC) must meet very stringent design and performance specifications. In many applications for communication devices, transmit and receive signals are exchanged over communication channels. These communication channels include impairments that affect the quality of the signal that traverses them. One type of IC that uses both a transmit element and a receive element is referred to as a serializer/deserializer (SERDES). The transmit element on a SERDES typically sends information to a receiver on a different SERDES over a communication channel. The communication channel is typically located on a different structure from where the SERDES is located. To correct for impairments introduced by the communication channel, a transmitter and/or a receiver on a SERDES or other IC may include circuitry that performs channel equalization. Channel equalization is a broad term that comprises many different technologies for improving the accuracy of communication between a transmitter and a receiver. One typical type of equalization is referred to as decision feedback equalization and is performed by a decision feedback equalizer (DFE). A DFE is typically implemented in a receiver and improves the signal-to-noise ratio (SNR) of the signal, but it can suffer from burst error propagation.

A feed forward equalizer (FFE) does not suffer from burst error propagation, but nor does it provide the improvement in SNR as does a DFE.

Additionally, a DFE can only be utilized for post cursor equalization, where a FFE can be used for either or both of pre or post cursor equalization.

Further, current FFE implementations use a trans-conductance (gm) stage to implement, thus making such an implementation inefficient with respect to power consumption and die area.

Moreover, these drawbacks become more pronounced when attempting to design and fabricate a receiver that can operate using both PAM 2 and PAM 4 modalities. The acronym PAM refers to pulse amplitude modulation, which is a form of signal modulation where the message information is encoded into the amplitude of a series of signal pulses. PAM is an analog pulse modulation scheme in which the amplitude of a train of carrier pulses is varied according to the sample value of the message signal. A PAM 2 communication modality refers to a modulator that takes one bit at a time and maps the signal amplitude to one of two possible levels (two symbols), for example −1 volt and 1 volt. A PAM 4 communication modality refers to a modulator that takes two bits at a time and maps the signal amplitude to one of four possible levels (four symbols), for example −3 volts, −1 volt, 1 volt, and 3 volts. For a given baud rate, PAM 4 modulation can transmit up to twice the number of bits as PAM 2 modulation.

These drawbacks can be mitigated using forward error correction (FEC). FEC generally comprises techniques used for controlling errors in data transmission over unreliable or noisy communication channels. Generally, the sending device encodes a message in a redundant way by using an error-correcting code (ECC). The redundancy allows the receiver to detect a limited number of errors that may occur anywhere in the message, and often to correct these errors without retransmission. FEC gives the receiver the ability to correct errors without needing a reverse channel to request retransmission of data, but at the cost of a fixed, higher forward channel bandwidth. FEC is therefore applied in situations where retransmissions are costly or impossible, such as one-way communication links.

An amount of FFE and DFE applied to a communication signal can be different based on the presence or absence of FEC in a receiver system. For example, a receiver without FEC may operate better with more DFE relative to FFE, while a receiver with FEC may operate better with more FFE relative to DFE correction.

Therefore, it would be desirable to have a way to adjust an amount of FFE and DFE in a receiver based on whether there is forward error correction (FEC) present and based on a channel performance parameter, such as bit error rate (BER).

### SUMMARY

In an embodiment, a pipelined receiver comprises a programmable feed forward equalizer (FFE), a programmable decision feedback equalizer (DFE), and logic for controlling a ratio of FFE and DFE to apply to a received signal based on at least one channel parameter.

Other embodiments are also provided. Other systems, methods, features, and advantages of the invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic view illustrating an example of a communication system in which the modal PAM2/4 pipelined programmable receiver having feed forward equalizer (FFE) and decision feedback equalizer (DFE) optimized for forward error correction (FEC) bit error rate (BER) performance can be implemented.

FIG. 2 is a schematic diagram illustrating an example receiver of FIG. 1.

FIG. 3 is a schematic diagram of a unit cell of the FFE of FIG. 2.

FIG. 4 is a block diagram illustrating a portion of a programmable FFE.

FIG. 5 is a timing diagram that can be used to control the operation of the programmable FFE of FIG. 4.

FIG. 6A is a schematic diagram of a unit cell of the DFE of FIG. 2.

FIG. 6B is a schematic diagram of a unit cell of the DFE of FIG. 2.

FIG. 7 is a schematic diagram illustrating an example 3 bit digital-to-analog converter (DAC) having an R2R architecture.

FIG. 8 is a schematic diagram illustrating an example 10 bit digital-to-analog converter (DAC) having an R2R architecture.

FIG. 9 is a graphical diagram of an 8-phase clock signal supplied to the DFE clock generation logic of FIGS. 6A and 6B.

FIG. 10 is a block diagram illustrating a single-ended example of a DFE unit cell.

FIG. 11 is a timing diagram that can be used to control the operation of the DFE unit cell of FIG. 10.

FIGS. 12A and 12B are diagrams showing the relationship between the output of the DFE unit cell of FIG. 10 and a PAM 4 feedback word.

FIG. 13 is a graph showing a relationship between FFE and DFE as it relates to a communication pulse.

FIG. 14 is a block diagram showing an example implementation of FFE and DFE in a receiver.

FIG. 15 is a flow chart illustrating an embodiment of a method for operating a pipelined programmable receiver having feed forward equalizer (FFE) and decision feedback equalizer (DFE) optimized for forward error correction (FEC) bit error rate (BER) performance.

### DETAILED DESCRIPTION

A modal PAM2/4 pipelined programmable receiver having feed forward equalizer (FFE) and decision feedback equalizer (DFE) optimized for forward error correction (FEC) bit error rate (BER) performance (hereafter referred to as a modal PAM2/PAM4 FFE DFE receiver optimized for FEC) can be implemented in any integrated circuit (IC) that uses a digital direct conversion receiver (DCR). In an embodiment, the modal PAM2/PAM4 FFE DFE receiver optimized for FEC is implemented in a serializer/deserializer (SERDES) receiver operating at a 50 gigabit per second (Gbps) data rate by implementing a pulse amplitude modulation (PAM) 4 modulation methodology operating at 25 GBaud (Gsymbols per second). The 50 Gbps data rate is enabled, at least in part, by the pipelined implementation to be described below, and is backward compatible with PAM 2 modulation methodologies operating at a data rate of 25 Gbps.

As used herein, the term “cursor” refers to a subject bit, the term “pre-cursor” or “pre” refers to a bit that precedes the “cursor” bit and the term “post-cursor” or “post” refers to a bit that is subsequent to the “cursor” bit.

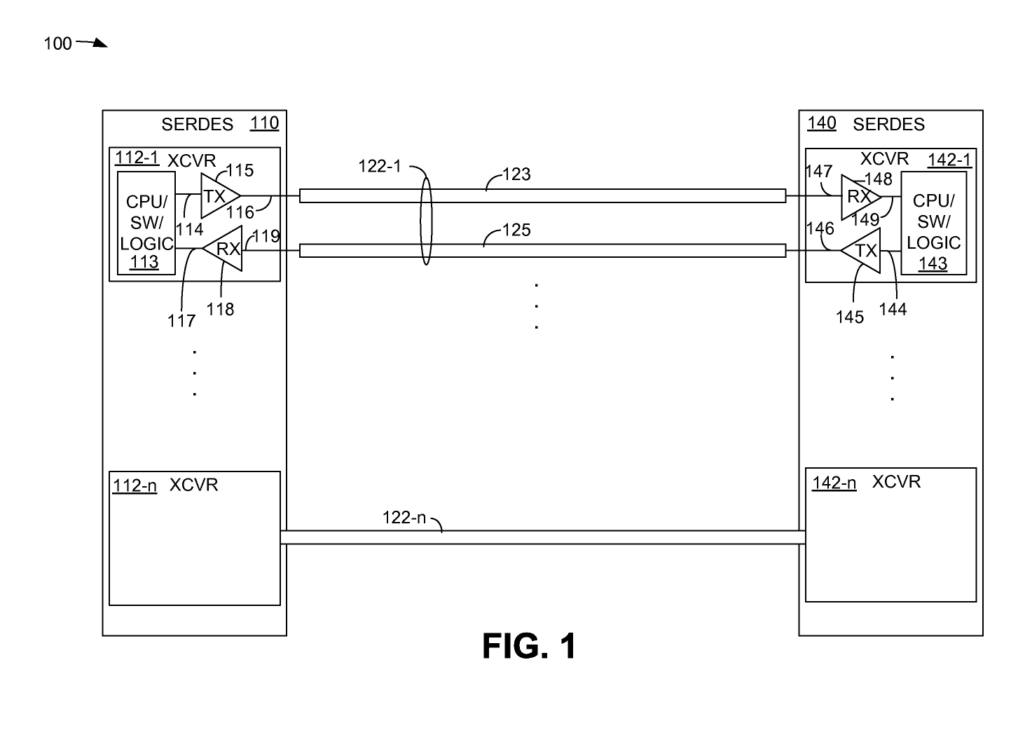

FIG. 1 is a schematic view illustrating an example of a communication system 100 in which the modal PAM2/PAM4 FFE DFE receiver optimized for FEC can be implemented. The communication system 100 is an example of one possible implementation. The communication system 100 comprises a serializer/deserializer (SERDES) 110 that includes a plurality of transceivers 112. Only one transceiver 112-1 is illustrated in detail, but it is understood that many transceivers 112-n can be included in the SERDES 110.

The transceiver 112-1 comprises a logic element 113, which includes the functionality of a central processor unit (CPU), software (SW) and general logic, and will be referred to as “logic” for simplicity. It should be noted that the depiction of the transceiver 112-1 is highly simplified and intended to illustrate only the basic components of a SERDES transceiver.

The transceiver 112-1 also comprises a transmitter 115 and a receiver 118. The transmitter 115 receives an information signal from the logic 113 over connection 114 and provides a transmit signal over connection 116. The receiver 118 receives an information signal over connection 119 and provides a processed information signal over connection 117 to the logic 113.

The system 100 also comprises a SERDES 140 that includes a plurality of transceivers 142. Only one transceiver 142-1 is illustrated in detail, but it is understood that many transceivers 142-n can be included in the SERDES 140.

The transceiver 142-1 comprises a logic element 143, which includes the functionality of a central processor unit (CPU), software (SW) and general logic, and will be referred to as “logic” for simplicity. It should be noted that the depiction of the transceiver 142-1 is highly simplified and intended to illustrate only the basic components of a SERDES transceiver.

The transceiver 142-1 also comprises a transmitter 145 and a receiver 148. The transmitter 145 receives an information signal from the logic 143 over connection 144 and provides a transmit signal over connection 146. The receiver 148 receives an information signal over connection 147 and provides a processed information signal over connection 149 to the logic 143.

The transceiver 112-1 is connected to the transceiver 142-1 over a communication channel 122-1. A similar communication channel 122-n connects the “n” transceiver 112-n to a corresponding “n” transceiver 142-n.

In an embodiment, the communication channel 122-1 can comprise communication paths 123 and 125. The communication path 123 can connect the transmitter 115 to the receiver 148 and the communication path 125 can connect the transmitter 145 to the receiver 118. The communication channel 122-1 can be adapted to a variety of communication methodologies including, but not limited to, single-ended, differential, or others, and can also be adapted to carry a variety of modulation methodologies including, for example, PAM 2, PAM 4 and others. In an embodiment, the receivers and transmitters operate on differential signals. Differential signals are those that are represented by two complementary signals on different conductors, with the term “differential” representing the difference between the two complementary signals. The two complementary signals can be referred to as the “true” or “t” signal and the “complement” or “c” signal. All differential signals also have what is referred to as a “common mode,” which represents the average of the two differential signals. High-speed differential signaling offers many advantages, such as low noise and low power while providing a robust and high-speed data transmission.

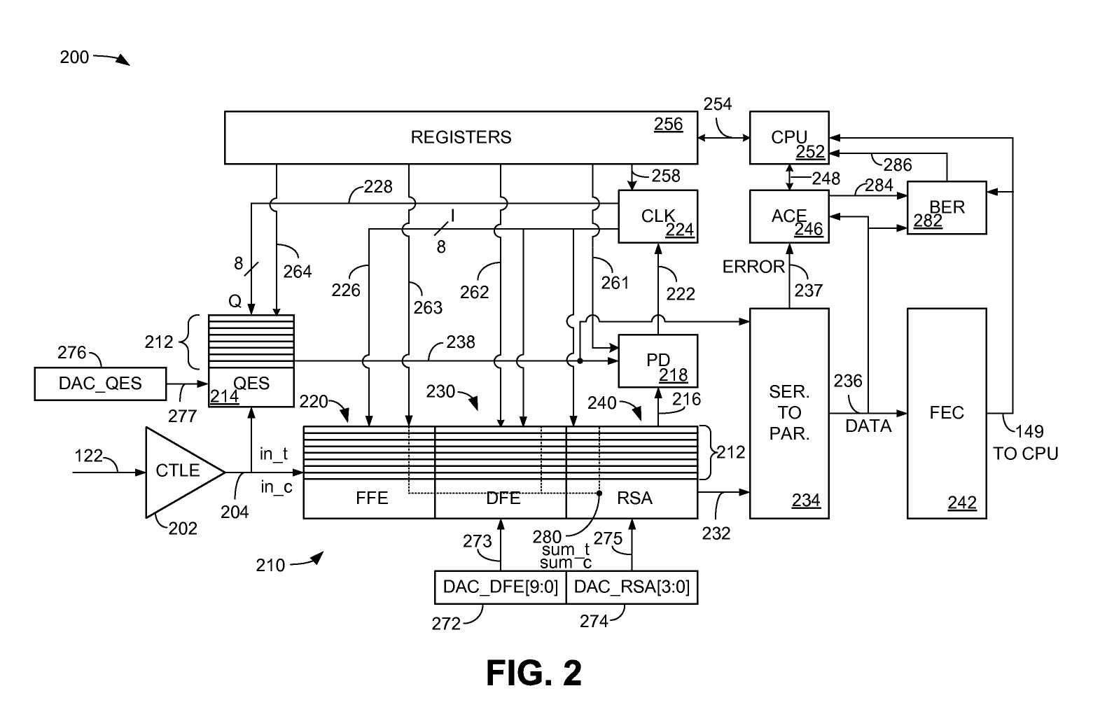

FIG. 2 is a schematic diagram illustrating an example receiver of FIG. 1. The receiver 200 can be any of the receivers illustrated in FIG. 1. The receiver 200 comprises a continuous time linear equalizer (CTLE) 202 that receives the information signal from the communication channel 122 (FIG. 1). The output of the CTLE 202 is provided to a quadrature edge selection (QES) element 214 and to a pipelined processing system 210. The pipelined processing system 210 comprises a pipelined feed forward equalizer (FFE) 220, a pipelined decision feedback equalizer (DFE) 230 and a regenerative sense amplifier (RSA) 240.

The reference to a “pipelined” processing system refers to the ability of the FFE 220, the DFE 230, the RSA 240 and the QES 214 to process 8 pipelined stages 212 (referred to below as sections D0 through D7) simultaneously.

The DFE 230 receives a threshold voltage input from a digital-to-analog converter (DAC) 272 over connection 273. The RSA 240 receives a threshold voltage input from a digital-to-analog converter (DAC) 274 over connection 275. The DAC 272 and the DAC 274 can be any type of DAC that can supply a threshold voltage input based on system requirements.

In each pipelined stage 212, the FFE 220 and the DFE 230 generate analog outputs, which are summed together at summing node 280, referred to as “sum_t” and “sum_c.” The summing node 280 is also the input to RSA 240, which acts as an analog-to-digital converter. The RSA 240 converts an analog voltage into a complementary digital value.

The RSA 240 converts an analog voltage into a complementary digital value. The output of the RSA comprises sampled data/edge information and is provided over connection 216 to a phase detector (PD) 218. The output of the phase detector 218 comprises an update signal having, for example, an up/down command, and is provided over connection 222 to a clock (CLK) element 224. The clock element 224 provides an in-phase (I) clocking signal over connection 226 and provides a quadrature (Q) clocking signal over connection 228. The in-phase (I) clocking signal is provided to the pipelined FFE 220, the DFE 230, and to the RSA 240; and the quadrature (Q) clocking signal is provided to the QES element 214.

The QES element 214 receives a threshold voltage input from a DAC 276 over connection 277. The DAC 276 can be any type of DAC that can supply a threshold voltage input based on system requirements.

The output of the RSA 240 on connection 232 is a digital representation of the raw, high speed signal prior to extracting any line coding, forward error correction, or demodulation to recover data. In the case of PAM 2, the output is a sequence of ones and zeros. In the case of PAM N, it is a sequence of N binary encoded symbols. For example, for PAM 4, the output comprises a string of four distinct symbols each identified by a different two bit digital word. The output of the RSA 240 is provided over connection 232 to a serial-to-parallel converter 234. The serial-to-parallel converter 234 converts the high speed digital data stream on connection 232 to a lower speed bus of parallel data on connection 236. The output of the serial-to-parallel converter 234 on connection 236 is the parallel data signal and is provided to a forward error correction (FEC) element 242. Although shown as being implemented with an FEC element 242, the receiver 200 need not include forward error correction. The modal PAM2/PAM4 FFE DFE receiver optimized for FEC can be implemented in a receiver with or without FEC, and can be used to optimize receiver performance whether or not an FEC is present.

The output of the serial-to-parallel converter 234 on connection 237 is an error, or test, signal and is provided to an automatic correlation engine (ACE) 246. The error, or test, signal is used to drive system parameters to increase signal-to-noise ratio in the receiver 200, and can be generated in several ways. One way is to use samplers inside the QES element 214 to identify zero crossings (also called edge data, or the transition between data bits). Another method is to use auxiliary samplers inside the RSA element 240 to identify the high amplitude signals (equivalent to the open part of an eye diagram). So, for example, using the edge data method, if a sampler inside the QES element 214 began to detect a positive signal where the zero crossing point should occur, then the ERROR signal on connection 237 would increase, and various system parameters could be driven to reduce that error. The output of the FEC 242 is provided over connection 149 to the CPU 252.

The output of the ACE 246 is provided over connection 248 to the CPU 252. The implementation of the ACE 246 could be done with hardware on chip, firmware off chip, or a combination of hardware and firmware, and a CPU, in which case the CPU 252 would read and write to the ACE 246 over connection 248. The ACE 246 compares the received data to a pseudorandom binary sequence (PRBS) pattern and provides a correlation function to support implementation of a least mean square (LMS) algorithm for tuning the receiver 200.

The CPU 252 is connected over a bi-directional link 254 to registers 256. The registers 256 store DFE filter coefficients, FFE controls, CTLE controls, RSA threshold voltage controls, offset correction values for the RSA and QES elements, and controls for the DACs.

An output of the registers 256 on connection 261 is provided to the phase detector 218, an output of the registers 256 on connection 262 is provided to the pipelined DFE 230, an output of the registers 256 on connection 263 is provided to the pipelined FFE 220 and an output of the registers 256 on connection 264 is provided to the QES element 214. Although not shown for simplicity of illustration, the registers 256 also provide control outputs to the CTLE 202 and to all the DACs. In an embodiment, the output of the QES element 214 on connection 238 comprises sampled data/edge information and is provided to the phase detector 218 and the serial-to-parallel converter 234.

In an embodiment, a channel performance parameter, such as bit error rate (BER) can be used as an indicator of channel performance. The BER can then be used to set, adjust or establish receiver parameters, such as a number and gain of FFE taps and DFE taps; and also to determine an optimal ratio of FFE to DFE implementation. In this regard, the receiver 200 also comprises a BER element 282. The BER element 282 can operate in a number of different ways, as known to those having ordinary skill in the art.

For example, in an embodiment in which pseudorandom binary sequence (PRBS) data is being sent, the data stream can be used by the BER element 282 to determine errors. In such an embodiment, the BER element 282 receives the data stream over connection 236, and, if the FEC 242 is implemented, receives the output of the FEC element 242 over connection 149. The BER element 282 uses the data stream over connection 236 and the output of the FEC 242 to determine errors in the data stream, and provides the error information to the CPU 252 over connection 286. If the FEC 242 is not implemented, then the BER element 282 receives only the data on connection 236, and determined errors solely from the data stream.

In an embodiment in which PRBS data is not sent, then exclusive Or (XOR) errors can be monitored via appropriately offset (test-data) RSA samplers & normal (good-data) RSA samplers via the ACE element 246, as known to those having ordinary skill in the art. In such an implementation, the XOR errors are provided from the ACE element 246 to the BER element 282 over connection 284. The BER element 282 then determines errors in the data stream, and provides the error information to the CPU 252 over connection 286.

In another implementation, mission FEC encoded data can detect errors internal to the FEC element 242, and provide the errors to the BER element 282 over connection 149. As used herein, the term “mission FEC encoded data” refers to live data (as opposed to PRBS data) that has at least some protocol-level encoding. A common protocol is Reed-Solomon error correction encoding. The BER element 282 then determines errors in the data stream, and provides the error information to the CPU 252 over connection 286. The CPU 252 then uses the BER information to adjust the FFE 220 and the DFE 230 via the registers 256. The adjustment of the FFE 220 and the DFE 230 can comprise one or more of the number of FFE and DFE stages implemented and the gain of each FFE and DFE stage.

The elements in FIG. 2 generally operate based on a system clock signal that runs at a particular frequency, which corresponds to the baud rate of the data channel. A time period, referred to as a unit interval (UI) generally corresponds to a time period of one clock cycle of the system clock. For example, a transceiver could be communicating at 50 Gbps, using PAM4, the baud rate is 25 G baud per second, and one UI would be 40 ps=1/25G.

Generally, a receive signal on connection 204 is applied to an array of FFE/DFE/RSA/QES sections. If an array of N sections is implemented, then each section can process the receive signal at a rate of 1/(UI*N) which significantly relaxes power requirements compared to the standard (un-pipelined) processing.

For example, a 25 Gbaud receive signal could be processed by an array of 8 sections, each section running at 3.125 GHz. The start time for each section is offset by 1 UI from its neighboring section, so that when the outputs from all 8 sections are summed together (signal 236), it is updated at the original 25 Gbaud rate.

### FFE

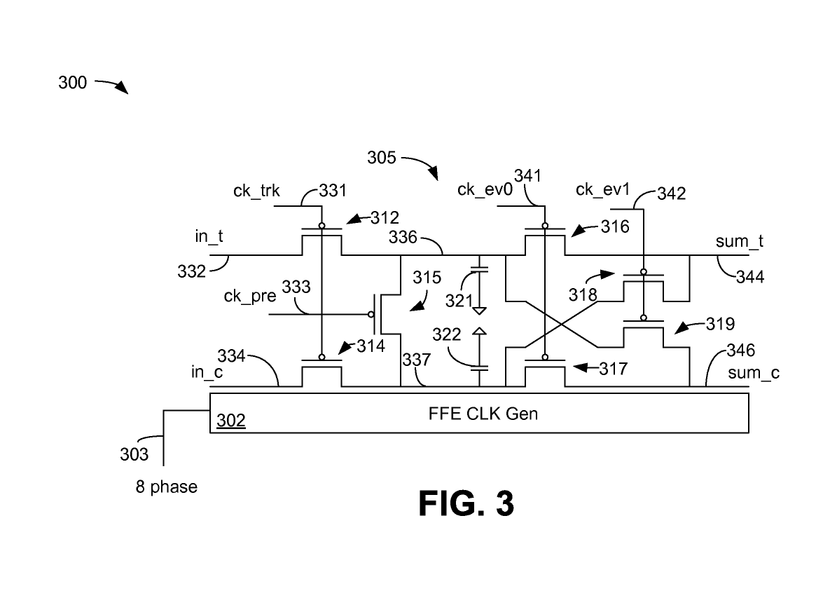

FIG. 3 is a schematic diagram of a unit cell of the FFE 220 of FIG. 2. The FFE unit cell 300 comprises FFE clock generation logic 302 and switching logic 305. The switching logic 305 comprises switches 312, 314, 315, 316, 317, 318 and 319. The switches can be implemented using any switching technology including, for example, bipolar junction transistor (BJT) logic or any variation thereof, field effect transistor (FET) logic or any variation thereof, or any other available switching technology.

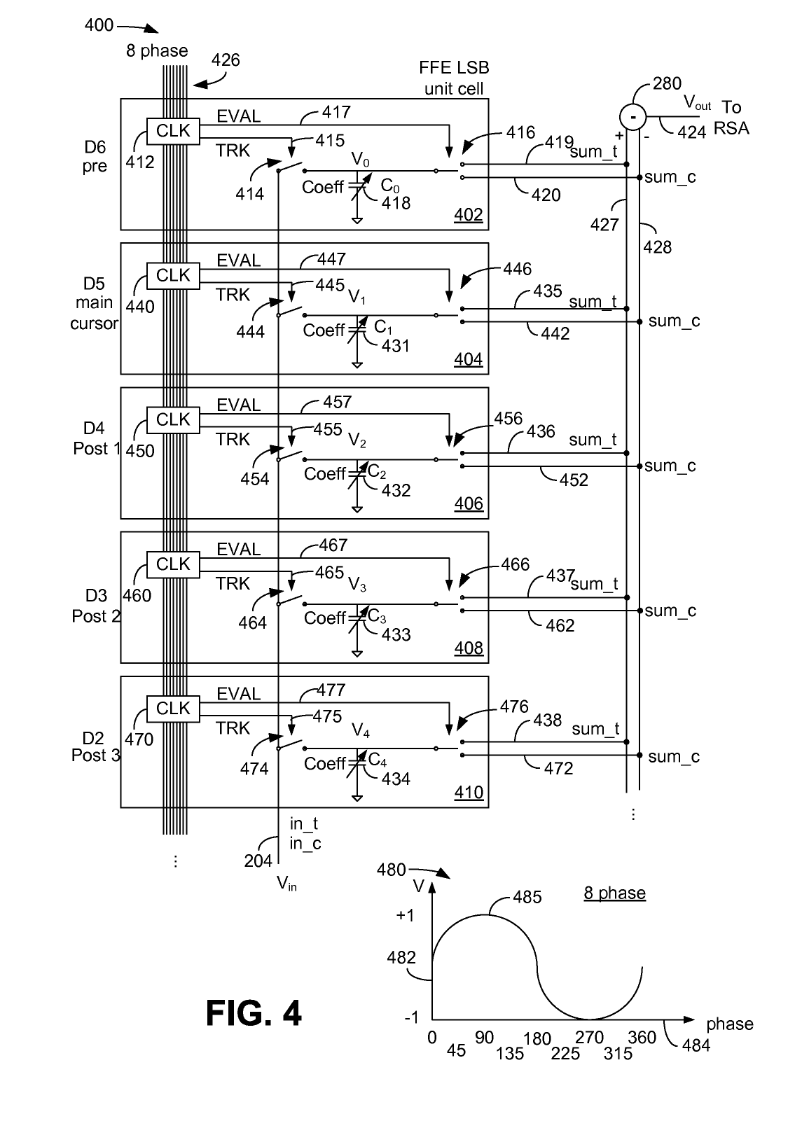

The FFE unit cell 300 also comprises a capacitor 321 and a capacitor 322. The FFE unit cell 300 is illustrated as operating on a differential signal with an input signal “in_t” provided on connection 332 and an input signal “in_c” provided on connection 334. The “in_t” signal and the “in_c” signal are the “true” and “complement” differential data outputs of the CTLE 202 of FIG. 2. The switches 312 and 314 receive a “track” clock signal “ck_trk”, the switches 316 and 317 receive an “evaluation” clock signal “ck_ev0” and the switches 318 and 319 receive an “evaluation” clock signal “ck_ev1.” The switch 315 receives a “precharge” clock signal “ck_pre” on connection 333. The “track” signal, the “evaluation” signal and the “precharge” signal will be described in greater detail below. The “true” output “sum_t” of the FFE unit cell 300 is provided over connection 344 and the “complement” output “sum_c” is provided over connection 346. The outputs “sum_t” and “sum_c” are provided to a summing element embodied by the summing node 280 (FIG. 4).

The clock generation logic 302 receives an 8-phase clock input signal on connection 303 and generates appropriate clock signals to allow the FFE unit cell 300 to switch at the appropriate time, and will be described in greater detail below.

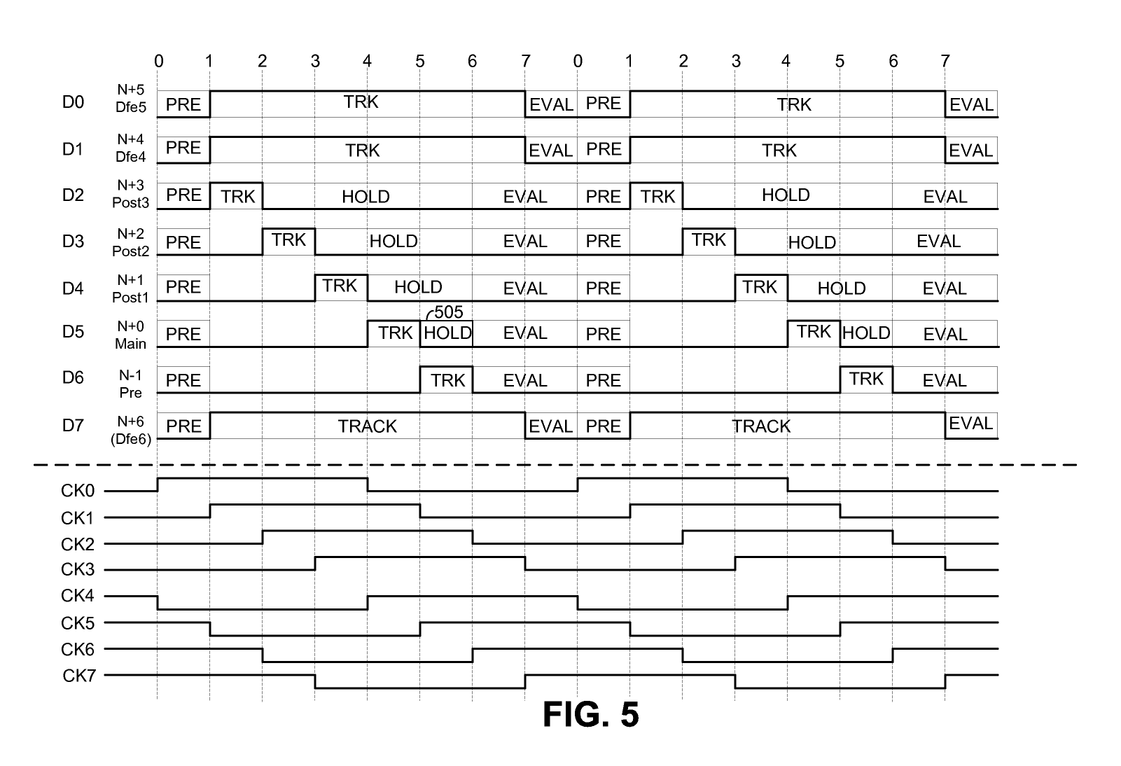

FIG. 4 is a block diagram illustrating a portion of a programmable FFE. FIG. 5 is a timing diagram that can be used to control the operation of the programmable FFE of FIG. 4. In this simplified example, the programmable FFE 400 represents one of eight pipelined parallel sections, with the section 400 comprising a plurality of FFE LSB (least significant bit) unit cells 402, 404, 406, 408 and 410. The FFE LSB unit cells 402, 404, 406, 408 and 410 can be similar to the FFE unit cell 300 described above, but are illustrated in FIG. 4 as a “single-ended” implementation using “positive logic” for ease of description. However, in an embodiment, the differential implementation shown in FIG. 3 uses PMOS (p-type metal oxide semiconductor) switches (where logic low or zero is ON, and logic high or one is OFF), so when the evaluation signal, “EVAL” is shown to transition to logic high in FIG. 5, it corresponds to the ck_ev0 (or ck_ev1) signal transitioning to logic low, in FIG. 3.

The FFE unit cell 402 comprises FFE clock generation logic 412, switches 414 and 416, and a capacitor 418. The capacitor 418 is illustrated as an adjustable capacitance as will be described below. An 8-phase clock signal is provided to the FFE clock generation logic 412 over an 8-phase clock bus 426. In the embodiment shown in FIG. 4, the FFE clock generation logic 412 provides a track signal, referred to as “TRK,” over connection 415 to control the operation of the switch 414, and provides an evaluation signal, referred to as “EVAL,” over connection 417 to control the operation of the switch 416. The FFE unit cells 404, 406, 408 and 410 are similar to the FFE unit cell 402 and will not be described in detail.

An input signal is provided to the FFE unit cells 402, 404, 406, 408 and 410 over connection 204, which is the “in_t” and “in_c” signals output of the CTLE 202 (FIG. 2). The output of the FFE unit cell 402 on connection 419 is the “sum_t” signal described in FIG. 3 and the output of the unit cell 402 on connection 420 is the “sum_c” signal described in FIG. 3. By operation of the switch 416, either the “sum_t” signal is provided to connection 427 or the “sum_c” signal is provided to connection 428. The “sum_t” signal and the “sum_c” signal are provided to the summing node 280. The output of the summing node 280 is provided over connection 424 to the RSA 240. The summing node 280 can also be referred to as a “difference element” in that it additively combines the “sum_t” signal on connection 427 and the “sum_c” signal on connection 428 to find the difference between those signals. In an embodiment, the summation can be done by shorting all of the FFE unit cell outputs on connections 427 and 428 together through a resistive short. However, other implementations of the summing node 280 can comprise active summation circuitry.

The sum_t signal on connection 419 and the sum_c signal on connection 420 is equivalent to the input signal on connection 204 modified by a programmable coefficient that is generated by operation of the FFE clock generation logic 412 selecting a subset of 8 available clock phases from the 8-phase clock input signal on the 8-phase clock bus 426 that is provided to the FFE unit cell 402, and similarly provided, to the FFE clock generation logic 440, 450, 460 and 470 in the FFE unit cells 404, 406, 408 and 410, respectively.

The FFE clock generation logic 412 uses a subset of clock phases (generated by using selected combinations) of the 8-phase clock input signal on the 8-phase clock bus 426 to generate the TRK signal on connection 415 and the EVAL signal on connection 417. The FFE clock generation logic 412 also generates a precharge signal, referred to as “PRE”, which is not shown in FIG. 4. The PRE signal is used to precharge the capacitor 418 (and similarly, the capacitors 431, 432, 433 and 434). The FFE 400 is one of eight parallel sections of the pipelined programmable FFE 220 (FIG. 2). One of the eight parallel sections (for example, the FFE section 400) would use clock phases 0->1, 4->5, and 6->0 in order to generate the PRE, TRK, and EVAL signal pulses. The nomenclature “6->0” refers to a signal pulse that starts at a rising edge of clock phase 6 “CK6” (FIG. 5) and ends on the rising edge of clock phase 1 “CK1” (FIG. 5). A neighboring instance of the FFE 400 (not shown) would operate on the identical logic as shown in FIG. 4 to drive the PRE, TRK and EVAL signals, but it would be operating on a shifted set of the 8 clock phases. So, the neighboring instance of the FFE 400 would use clock phases 1->2, 5->6, and 7->1 to generate the PRE, TRK and EVAL signals. Each successive section of FFE 400 would be responsive to a shift in the clock phases in a similar manner, and so would have its main cursor sampling 1 UI later than a previous FFE section. After 8 FFE sections process the input signal, the clock phases return to the original, and have completed one complete phase. The graph 480 illustrates such a phase having 8 sampled clock phases.

The specific phases selected from the 8-phase clock signal on bus 426 define the time that the voltage at the input 204 is sampled onto the capacitor 418 (and the capacitors 431, 432, 433 and 434), through switch 414 (and the switches 444, 454, 464 and 474), and later through the switch 416 (and switches 446, 456, 466 and 476) and applied to the summing node 280.

With particular regard to the FFE unit cell 402, but applicable to the unit cells 404, 406, 408 and 410, the FFE clock generation logic 412 controls the operation of the switches 414 and 416 to control and determine the time that the input voltage on connection 204 is applied to the capacitor 418, thus adjustably controlling, or programming, the value of the capacitor 418, and thus determining the value of the coefficient on connection 419 or connection 420. The time that the input voltage is applied to the capacitors 431, 432, 433 and 434, is similarly controlled by respective FFE clock generation logic 440, 450, 460 and 470, thus determining the total value of the signal on connection 424. Similarly, by adjusting the number of FFE LSB unit cells enabled for each cursor, the FFE 220 provides a widely adjustable coefficient to the input signal on connection 204.

The value of the signal on connection 424 is generated by multiplying the input signal (Vin) on connection 204 by a coefficient (Coeff, corresponding to the value of each capacitance C₀ through C₄, in this embodiment) to generate the output (Vout), so Vout=Coeff*Vin. In such an example, the value of the “Coeff” is set by the size of the capacitor 418 (and 431, 432, 433 and 434). However, in an alternative embodiment, the value of the coefficient (Coeff) can be determined by enabling or disabling FFE LSB cells (more cells in parallel is equivalent to one cell with a bigger capacitor), or by changing whether an FFE LSB cell provides an output to sum_t, or to sum_c. For example, if an FFE unit cell provides an output to sum_c, it is applying a negative coefficient, and if it provides an output to sum_t is applying a positive coefficient. In an embodiment, a combination of these three methodologies is used to generate the overall value on connection 424.

In the example of FIG. 4 having five FFE unit cells, the value of the coefficient applied to the input signal, Vᵢₙ, is given by (C₀V₀+C₁V₁+C₂V₂+C₃V₃+C₄V₄)/(Ctotal). The value of each capacitor 418, 431, 432, 433 and 434 is fixed (and programmable by virtue of the registers 256) and the value of the voltage across each capacitor 418, 431, 432, 433 and 434 is determined by the value of the voltage at the input on connection 204, at the specific time that each FFE unit cell samples the input on connection 204, as controlled by the FFE clock generation logic associated with each FFE unit cell.

With regard to the FFE unit cell 402, but applicable to the FFE unit cells 404, 406, 408 and 410, the FFE clock generation logic 412 controls the timing of the switches 414 and 416 and the registers 256 (FIG. 2) control the polarity of the switch 416 (to determine whether the capacitor 418 is applied to sum_t or sum_c, and can enable or disable any unit FFE cell via connection 263 (FIG. 2). Together, the FFE clock generation logic 412 and the registers 256 enable a programmable feed forward equalization of the input signal on connection 204, with the equalized output provided at the summing node 280. In this embodiment, the FFE clock generation logic 412 is configured to sample the input on connection 204 through the switch 414, onto capacitor 418 (C₀), during the UI before the main cursor (the precursor). By enabling or disabling FFE LSB cells that are configured to sample the precursor (D6), more or less of the precursor component of the input signal can be programmed into the output of the FFE section 400. An alternative way of programming the output of the FFE section 400 can be done by increasing or decreasing the size of the capacitor 418 (C₀). The polarity of the EVAL signal controls the sign of each FFE LSB cell's contribution to the output on connections 427 and 428. In this embodiment, the voltage V₀ is a copy of the input signal on connection 204 during the precursor time interval (D6), the voltage V₁ is the main cursor at time interval D5, the voltage V₂ is the first postcursor (D4), the voltage V₃ is the second postcursor (D3), and the voltage V₄ is the third postcursor (D2). The adjustable amount that each cursor is scaled, then delivered to the output of the equalizer on connection 424, is determined by the total capacitance used to sample each cursor. The capacitance C₀ scales the precursor (D6), the capacitance C₁ scales the main cursor (D5), the capacitance C₂ scales the first postcursor (D4), the capacitance C₃ scales the second postcursor (D3), and the capacitance C₄ scales the third postcursor (D2). Additionally, the polarity of the EVAL signal controls the switch 416 (and the respective switches 446, 456, 466 and 476) to determine whether each cursor's contribution is positive or negative. The resulting output of the FFE section 400 is (C₀V₀+C₁V₁+C₂V₂+C₃V₃+C₄V₄)/(Ctotal) where each coefficient C₀ . . . C₄ can be positive or negative, and has a value based on the total capacitance used to sample the given cursor.

A graphical example of the input signal provided to the FFE clock generation logic 412 is shown in the graph 480. The vertical axis 482 of the graph 480 refers to relative amplitude in volts (V), with a normalized value range of between −1V and +1V. The horizontal axis 484 refers to the phase of the signal on connection 426. The signal on connection 426 is sampled at 45 degree intervals to generate the 8 clock phases in one clock cycle represented by the trace 485. The FFE clock generation logic in each FFE unit cell selects the appropriate subset of the 8 clock phases to control the operation of each FFE unit cell 402, 404, 406, 408 and 410 to apply a selectable coefficient to the input via respective capacitors 418, 431, 432, 433 and 434, to generate a widely programmable equalized output voltage on connection 424. In an embodiment, the FFE clock generation logic 412 can be implemented as a 1:8 demultiplexer, where each of the 8 outputs is a signal that is separated in phase from each adjoining output by 45 degrees and having a different voltage value.

The input signal on connection 204 to the FFE cells 402, 404, 406, 408 and 410 will be described in conjunction with the timing diagram of FIG. 5. The timing diagram 500 illustrates an example of 8 clock phases being used to control the operation of the programmable FFE 400 of FIG. 4, as an example. The signal traces “CK0” through “CK7” refer to the clock signals being applied to the FFE clock generation logic 412 on the 8-phase clock bus 426 to control the programmability of the capacitors associated with each FFE unit cell shown in FIG. 4.

The traces labeled “D0” through “D7” in FIG. 5 correspond to sections of FFE unit cells (FIG. 4) that are programmed by the FFE clock generation logic based on the clock signals CK0 through CK7 which sample the input signal on connection 204 on specific cursors (pre (D6), main (D5), post1 (D4), etc.) that are related to the clock phases as shown in the timing diagram of FIG. 5. In the example of FIG. 4 and FIG. 5, the traces D0 through D7 refer to sections of the FFE 220 and DFE 230, with the FFE portion 400 shown in FIG. 4 as an example of the FFE 220 that operates on the cursors “pre (D6),” “main (D5),” “post 1 (D4),” “post 2 (D3),” and “post 3 (D2)” according to the 8-phase clock. The timing provided by the FFE clock generation logic 412 (illustrated by the available clock signals CK0 through CK7) determines which cursor (D0 through D7) corresponds to which clock signal (CK0) through CK7), and the timing of the action of each unit cell (FIG. 4) on the input signal on connection 204. The repeating periods “0” through “7” along the top of FIG. 5 refer to system clock intervals, and are each referred to as a “UI” or unit interval of the system clock. The term “PRE” refers to a period during which the capacitors in each unit cell (e.g., the capacitors 321 and 332 in the differential unit cell shown in FIG. 3, and the capacitors 418, 431, 432, 433 and 434 shown in the unit cells of FIG. 4) are precharged. In an embodiment, the capacitors (e.g., the capacitors 321 and 322 in the differential unit cell shown in FIG. 3, and the capacitors 418, 431, 432, 433 and 434 shown in the single-ended implementation in FIG. 4) are precharged by connecting them together. During the “PRE” period, capacitors 321 and 322 (FIG. 3) are pre-charged by shorting them together by closing the switch 315 so they have zero differential voltage. In the single-ended implementation shown in FIG. 4, the two capacitors 321 and 322 of FIG. 3 are functionally equivalent to the capacitor 418 and to the capacitors 431, 432, 433 and 434 for unit cells 404, 406, 408 and 410, respectively. In FIG. 4, the “PRE” period would be equivalent to shorting the capacitor 418 to ground. More generally, the pre-charging switches could connect the capacitors to voltages other than zero, for example to shift the summing node voltage to be inside the range of the RSA, if necessary.

The terms “TRK” or “TRACK” refer to a tracking period during which the capacitor is connected to the input 204 to allow the capacitor to be charged to the input voltage on connection 204. Referring to FIG. 3, the clock signal “ck_trk” is applied to the switches 312 and 314 to charge the capacitors 321 and 322. Referring to FIG. 4, the switch 414 (and the other switches at the inputs to the unit cells 404, 406, 408 and 410) is closed so the capacitor 418 (and capacitors 431, 432, 433 and 434) is connected to the input voltage on connection 204.

The term “HOLD” refers to a hold period during which the capacitor is decoupled from the input node 204, and thus from the charging voltage and is allowed to remain in a charged state.

The term “EVAL” refers to an evaluation period during which the capacitors are coupled to the summing node 280. Referring to FIG. 3, the clock signal “ck_ev0” is applied to the switches 316 and 317; or the clock signal “ck_ev1” is applied to the switches 318 and 319 such that the values of the capacitors 321 and 322 are applied to the connections 344 and 346, to the summing node 280 and then to the RSA 240. The sign of the coefficient that each FFE LSB cell 402, 404, 406, 408 and 410 is contributing is controlled by which ck_ev signal (“ckev0” or “ckev1”) is enabled. In an embodiment, the signal “ck_ev0” applies a positive coefficient and the signal “ck_ev1” applies a negative coefficient. The number of FFE LSB cells 402, 404, 406, 408 and 410 enabled inside each FFE cursor (D2, D3, D4, D5, etc.) determines the magnitude of that coefficient.

As shown in FIG. 5, data corresponding to the main cursor sampled into the FFE unit cell 404 associated with trace D5 is held for one (1) UI, as shown by reference numeral 505 to allow the precursor bit sampled into FFE unit cell 402 associated with trace D6 to be brought into the programmable FFE 400 and be applied to the summing node 280 as described above.

By selecting the number of FFE LSB cells to enable for each cursor, and selecting the sign of the EVAL signals in those selected cells, an FFE filter function is implemented. The clock signals determine the time that each FFE LSB unit cell will sample the input on connection 204 thus determining which cursor on which FFE LSB unit cell will sample the input. In addition, the registers 256 provide control signals that enable more/less of each cursor to be applied to the summing node by controlling each FFE LSB cell to use the ck_ev0 or ck_ev1 signals to determine whether the coefficient is positive or negative. The registers 256 control whether the signal ck_ev0 or the signal ck_ev1 will be connected to the capacitor in each unit cell, and the FFE clock generation logic 412 circuit applies the input at the right time, using selected phases of the 8 phase clock.

The track (TRK) periods in each FFE unit cell should be aligned with specific cursors used for the equalizer. In the implementation described herein, there are five UIs (five FFE LSB unit cells in FIG. 4) during which the input on connection 204 can be sampled. In the implementation described herein, the selected cursors are the “pre”, “main”, “post1”, “post2”, and “post3” cursors, but more generally, it is possible to operate on the main cursor, and then four pre or post cursors as desired for that particular system.

### DFE

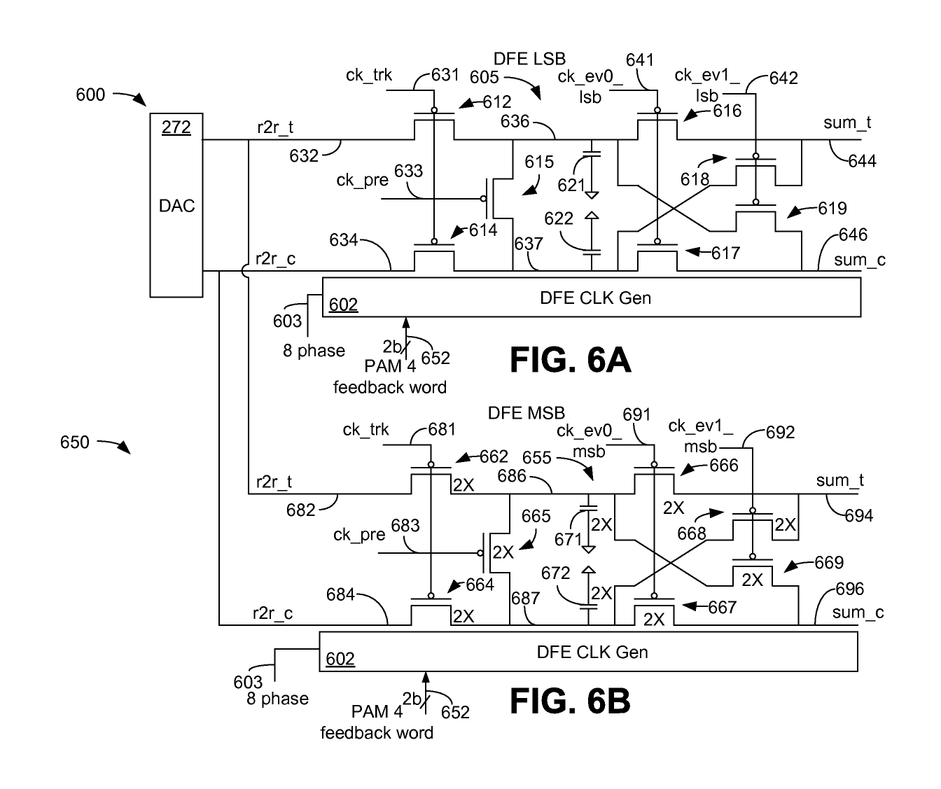

FIG. 6A is a schematic diagram of a unit cell 600 of the DFE 230 of FIG. 2. The DFE unit cell 600 is configured to operate on the least significant bit (LSB) of a PAM 4 feedback word. The DFE cell 600 comprises DFE clock generation logic 602 and switching logic 605. The switching logic 605 comprises switches 612, 614, 615, 616, 617, 618 and 619. The switches can be implemented using any switching technology including, for example, bipolar junction transistor (BJT) logic or any variation thereof, field effect transistor (FET) logic or any variation thereof, or any other available switching technology.

The DFE cell 600 also comprises a capacitor 621 and a capacitor 622. The DFE cell 600 is illustrated as operating on a differential signal with a “r2r_t” signal provided on connection 632 and a “r2r_c” signal provided on connection 634 from the DAC 272. The switches 612 and 614 receive a clock signal “ck_trk”, the switches 616 and 617 receive a clock signal “ck_ev0_lsb” and the switches 618 and 619 receive a clock signal “ck_ev1_lsb.” The switch 615 receives a clock signal “ck_pre” on connection 633. The “ck_pre” signal precharges the capacitors 621 and 622. The “true” output “sum_t” of the DFE cell 600 is provided over connection 644 and the “complement” output “sum_c” is provided over connection 646. The outputs “sum_t” and “sum_c” are provided to the RSA element 240 (FIG. 2).

The clock generation logic 602 receives an 8-phase input signal on connection 603 and receives a PAM 4 feedback word over connection 652. The clock generation logic 302 generates appropriate clock signals to allow the DFE cell 600 to switch at the appropriate time, and will be described in greater detail below.

FIG. 6B is a schematic diagram of a unit cell 650 of the DFE 230 of FIG. 2. The DFE unit cell 650 is configured to operate on the most significant bit (MSB) of a PAM 4 feedback word. The DFE cell 650 comprises DFE clock generation logic 602 and switching logic 655. The DFE clock generation logic 602 is shared by the switching logic 605 and the switching logic 655. The switching logic 655 comprises switches 662, 664, 665, 666, 667, 668 and 669. The switches can be implemented using any switching technology including, for example, bipolar junction transistor (BJT) logic or any variation thereof, field effect transistor (FET) logic or any variation thereof, or any other available switching technology.

The DFE cell 650 also comprises a capacitor 671 and a capacitor 672. The DFE cell 650 is illustrated as operating on a differential signal with a “r2r_t” signal provided on connection 682 and a “r2r_c” signal provided on connection 684 from the DAC 272. The switches 662 and 664 receive a clock signal “ck_trk”, the switches 666 and 667 receive a clock signal “ck_ev0_msb” and the switches 668 and 669 receive a clock signal “ck_ev1_msb.” The switch 665 receives a clock signal “ck_pre” on connection 683. The “ck_pre” signal precharges the capacitors 671 and 672. The “true” output “sum_t” of the DFE cell 650 is provided over connection 694 and the “complement” output “sum_c” is provided over connection 696. The outputs “sum_t” and “sum_c” are provided to the RSA element 240 (FIG. 2).

The value of the capacitors 621 and 622 in the DFE cell 600 are referred to as “1X” and the capacitors 671 and 672 in the DFE cell 650 are referred to as “2X.” Similarly, the switches 612, 614, 615, 616, 617, 618 and 619 are configured using the nomenclature “1×” to correspond to the 1× of the capacitors 621 and 622. The switches 662, 664, 665, 666, 667, 668 and 669 are configured using the nomenclature “2X” to correspond to the 2X of the capacitors 671 and 672. The components labeled “2X” are twice the value of the components labeled “1X.” By scaling the switch sizes by the same factor as the capacitor sizes, the charge and discharge times of the 1X or 2X cell is the same.

The clock generation logic 602 receives an 8-phase input signal on connection 603 and receives a PAM4 feedback word over connection 652. The clock generation logic 602 generates appropriate clock signals to allow the DFE cell 650 to switch at the appropriate time, and will be described in greater detail below.

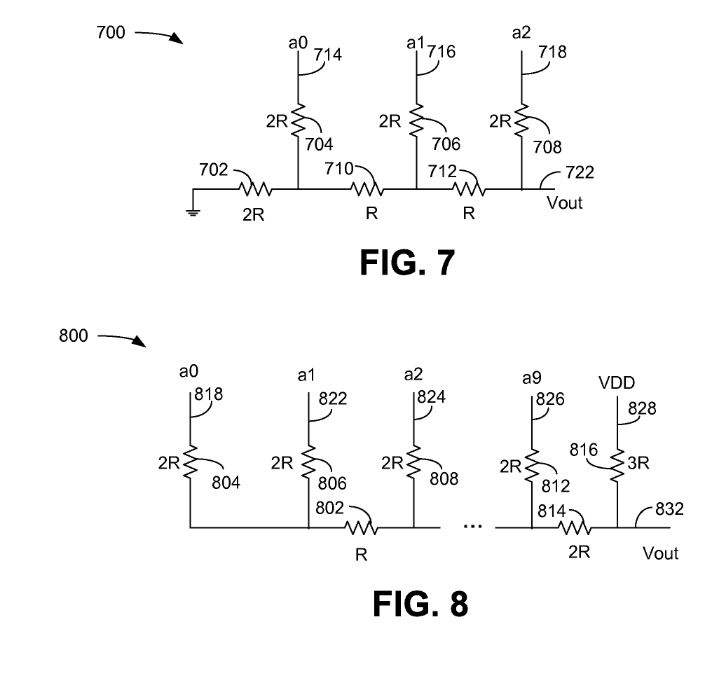

FIG. 7 is a schematic diagram illustrating an example 3 bit digital-to-analog converter (DAC) having an R2R architecture. The 3 bit DAC 700 comprises resistors 702, 704, 706, 708, 710 and 712, where the values of the resistors 710 and 712 are “R” and the values for the resistors 702, 704, 706 and 408 are “2R.” A first bit “a0” is the least significant bit (LSB) input on connection 714, a second bit “a1” is input on connection 716 and a third bit “a2” is the most significant bit (MSB) and is input on connection 718. The bits a0, a1 and a2 are driven by digital logic gates (not shown) and are ideally switched between zero volts (logic 0) and Vref (logic 1). The R2R architecture causes the digital bits to be weighted in their contribution to the output voltage Vout. In this example, three bits are shown (bits 2-0) providing 2³ or 8 possible analog voltage levels at the output. Depending on which bits are set to logic 0 and which bits are set to logic 1 the output voltage can be a corresponding stepped value between 0 volts and (Vref minus the value of the minimum step, bit 0 (bit a2 in this example)). The actual value of Vref (and 0 volts) will depend on the type of technology used to generate the digital signals.

The value of Vout on connection 722 is given by:

Vout=Vref·VAL/2^{N}, where Vref=VDD, and where N=the number of bits and VAL is the digital input value.

FIG. 8 is a schematic diagram illustrating an example 10 bit digital-to-analog converter (DAC) having an R2R architecture. The DAC 800 can be used as an implementation of the DAC 272 described above. In this example, the 10 bits are connected to the data stream and an 8b control word to make it effectively an 8b DAC. The 10 bit DAC 800 comprises resistors 802, 804, 806, 808, 810, 812, 814 and 816, where the values of the resistor 802 is “R”, the values for the resistors 804, 806, 808, 812 and 814 are “2R” and the value of the resistor 816 is “3R.” A first bit “a0” (the LSB) is input on connection 818, a second bit “a1” is input on connection 822, a third bit “a2” is input on connection 824, and a 10^{th} bit “a9” (the MSB) is input on connection 826. A system voltage “VDD” is provided on connection 828 to the “3R” resistor 816 to provide a Vcm voltage of VDD·0.75. The value of Vout on connection 832 is given by:

Vout=(0.5*(8b_Dac/255)+0.5)*VDD

8b_Dac=0->0.5*VDD

8b_Dac=127->0.749*VDD

8b_Dac=255->1.0*VDD

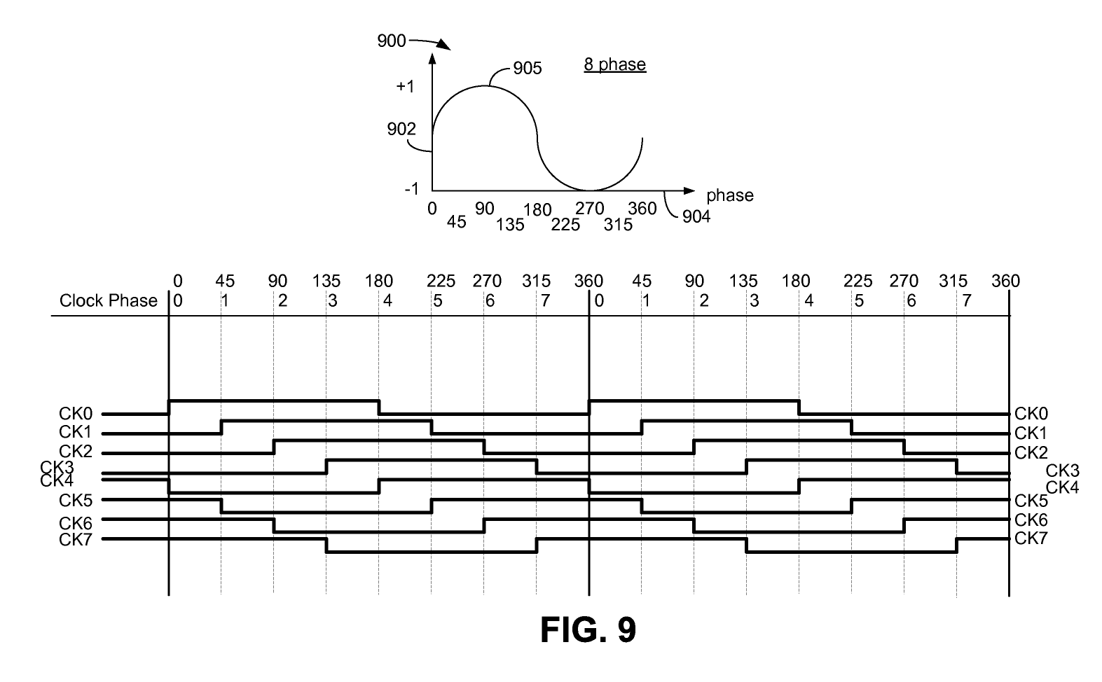

FIG. 9 is a graphical diagram of an 8-phase clock signal supplied to the DFE clock generation logic of FIGS. 6A and 6B. A graphical example of the input signal provided to the DFE clock generation logic 602 is shown in the graph 900. The vertical axis 902 of the graph 900 refers to relative amplitude in volts (V), with a normalized value range of between −1V and +1V. The horizontal axis 904 refers to the phase of the signal on connection 603. The signal on connection 603 (FIG. 6A and FIG. 6B) is sampled at 45 degree intervals to generate the 8 clock phases in one clock cycle represented by the trace 905. The 8 clock phases are also shown as signal traces CK0 through CK7. The repeating periods “0” through “7” refer to system clock intervals, and the time between each repeating period is referred to as a ‘UI” or unit interval of the system clock.

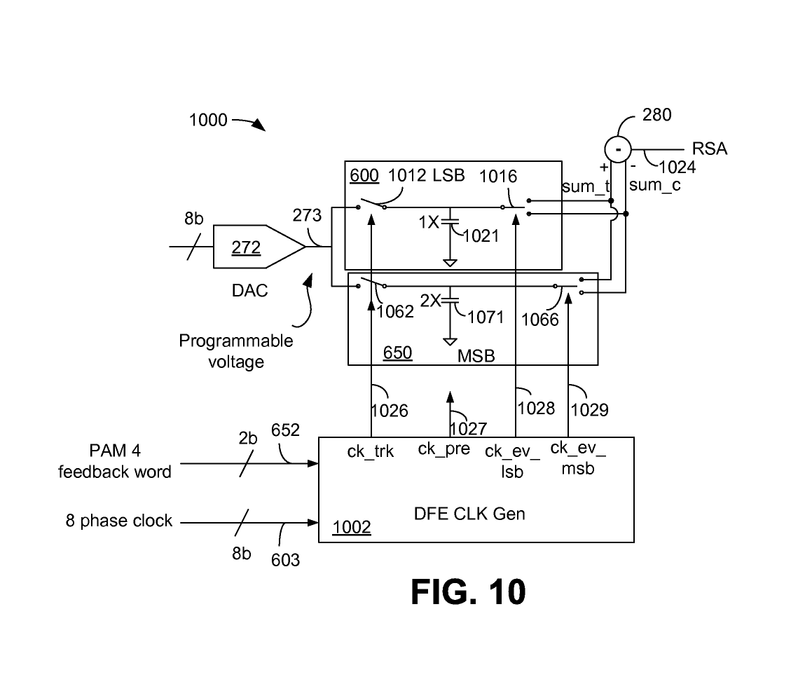

The DFE clock generation logic 602 selects the appropriate subset of the 8 clock phases to control the operation of each DFE unit cell to apply a selectable coefficient to the summing node (1022, FIG. 10) via respective capacitors 621, 622, 671 and 672, to generate a widely programmable equalized output voltage. In an embodiment, the DFE clock generation logic 602 can be implemented as a 1:8 demultiplexer, where each of the 8 outputs is a signal that is separated in phase from each adjoining output by 45 degrees and having a different voltage value.

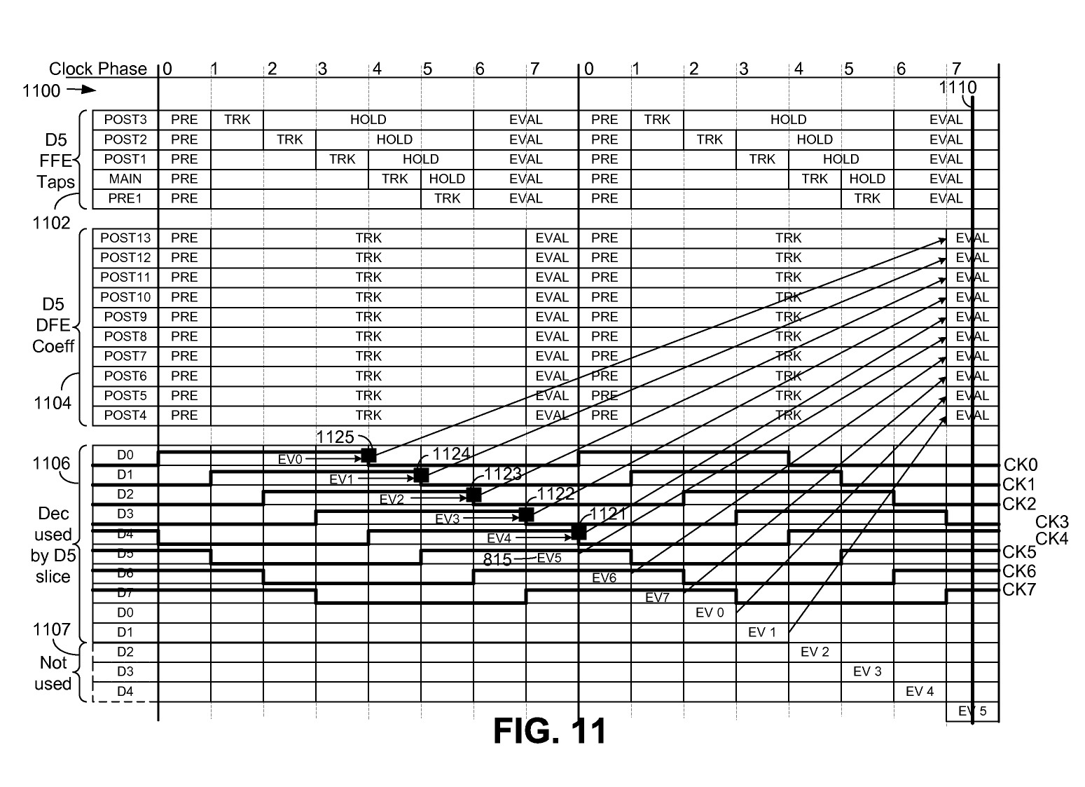

FIG. 10 is a block diagram illustrating a single-ended example of a DFE unit cell. FIG. 11 is a timing diagram that can be used to control the operation of the DFE unit cell of FIG. 10. The DFE unit cell 1000 receives input in the form of a programmable coefficient from the DAC 272. The DFE unit cell 1000 comprises an LSB block 600 (FIG. 6A) and an MSB block 650 (FIG. 6B). Together, the two bits processed by the DFE unit cell 1000 correspond to the two bits of the PAM 4 feedback decision word for one of the postcursors that will be processed by the DFE unit cell 1000. Feedback information from additional postcursors can be added to the output of a complete pipelined DFE, by implementing more DFE unit cells 1000 in parallel, all of the outputs being summed into the RSA input. In an embodiment, the DFE unit cell 1000 is one of ten instances of unit cells that operate on ten postcursors that are used to equalize the communication channel. The output of each DFE unit cell is provided to the summing node 280. The output of the summing node 280 is provided to the RSA 240 (FIG. 2).

The DAC 272 provides a programmable voltage over connection 273 to the LSB block 600 and the MSB block 650 through the switches 1012 and 1062, respectively. The switches 1012 and 1062 are controlled by the “ck_trk” signal from the DFE clock generation logic 1002 over connection 1026. The embodiment shown in FIG. 10 is shown as “single-ended” instead of “differential” as shown in FIGS. 6A and 6B for simplicity, where the capacitor 1021 corresponds to the capacitors 621 and 622 in FIG. 6A, and the capacitor 1071 corresponds to the capacitors 671 and 672 in FIG. 6B. The switch 1012 corresponds to the switches 612 and 614 in FIG. 6A and the switch 1062 corresponds to the switches 662 and 664 in FIG. 6B.

The switch 1016 is controlled by the “ck_ev_lsb” signal over connection 1028. The “ckev_lsb” signal corresponds to the “ck_ev0_lsb” signal and the “ck_ev1_lsb” signal in FIG. 6A. The switch 1016 corresponds to the switches 616, 617, 618 and 619 in FIG. 6A.

The switch 1066 is controlled by the “ck_ev_msb” signal over connection 1029. The “ck_ev_msb” signal corresponds to the “ck_ev0_msb” signal and the “ck_ev1_msb” signal in FIG. 6B. The switch 1066 corresponds to the switches 666, 667, 668 and 669 in FIG. 6B.

Referring to FIG. 10 and FIG. 11 the diagram 1100 shows the timing for the FFE 220 and DFE 230 for a single slice of the 8 pipelined stages. The clock phases CK0 through CK7 are shown in bold and are overlaid on the cursors D0 through D7 for simplicity of illustration only and do not necessarily relate only to the D0 through D7 instances shown in FIG. 11. The repeating periods “0” through “7” along the top of FIG. 11 refer to system clock intervals, and the time between each is referred to as a ‘UI” or unit interval of the system clock.

In the diagram 1100, detail is provided for slice 5, which samples the main cursor at clock phase 4.

The term “PRE” refers to a period during which the capacitors in each unit cell (e.g., the capacitors 621, 622, 671 and 672 in the differential unit cells shown in FIGS. 6A and 6B, and the capacitors 1021 and 1071, (shown in FIG. 10) are precharged over connection 1028.

The terms “TRK” or “TRACK” refer to a period during which the capacitor is connected to the output of the DAC 272. Referring to FIGS. 6A and 6B, the clock signal “ck_trk” is applied to the switches 612 and 614 to connect the capacitors 621 and 622 to the “r2r_t” and the “r2rc” output of the DAC 272, and is applied to the switches 662 and 664 to connect the capacitors 671 and 672 to the “r2r_t” and the “r2rc” output of the DAC 272.

The term “HOLD” refers to a hold period during which the capacitor is decoupled from the input of the DAC 272, and thus from the charging voltage and is allowed to remain in a charged state.

The term “EVAL” refers to a period during which the capacitors are coupled to the summing node 280. Referring to FIG. 6A, the clock signal “ck_ev0_lsb” is applied to the switches 616 and 617 (FIG. 6A) or the clock signal “ck_ev1_lsb” is applied to the switches 618 and 619 (FIG. 6A) such that the value of the capacitor 621 or the capacitor 622 (FIG. 6A) is applied to the connection 644 or 646 (FIG. 6A), to the summing node 280 and then to the RSA 240. Referring to FIG. 6B, the clock signal “ck_ev0_msb” is applied to the switches 666 and 667 (FIG. 6B) or the clock signal “ck_ev1_msb” is applied to the switches 668 and 669 (FIG. 6B) such that the value of the capacitor 671 or the capacitor 672 (FIG. 6B) is applied to the connection 694 or 696 (FIG. 6B), to the summing node 280 and then to the RSA 240.

The timing for the FFE section (220, FIG. 2) is illustrated by showing five FFE taps 1102 where the main cursor is referred to as the D5 slice. Sampling capacitors are pre-charged (“PRE”) in phase 0, then tracking of the input occurs at the proper times for pre, main, post1, post2, and post3 cursors. All values are held for a predetermined period of time and then applied to the summing node during the evaluation (EVAL) period at clock phases 6 and 7. Clock phase 7 is when slice 5 will have its RSA clocked, in order to determine the voltage at the summing node 280.

The DFE for slice 5 (shown using 1104) is always operating in parallel with the FFE (shown using 1102), and applying its output to the same summing node (summing node 280, FIG. 10) as the FFE for slice 5. Similar to the FFE 220, the DFE 230 has a pre-charge phase at clock phase 0 to eliminate residue from previous data.

In this embodiment, there are 10 DFE taps, referred to as DFE coefficients, with each tap corresponding to a particular cursor. The number of taps could be greater or smaller than 10, and depends on the particular application and the amount of equalization expected from the design. There can be more DFE taps (10) than there are pipeline stages (eight (8)), if previous decisions are stored in memory, as will be explained below. The DFE taps and the associated cursors are shown in the section 1104 of the diagram 1100. The diagram 1100 describes the timing associated with the D5 slice. During the track phase “TRK”, the DFE coefficient for each tap is sampled onto a capacitor (1021/1071) by the DAC 272. The DAC setting is equivalent to the value of the coefficient for a given cursor, and could also be referred to as the “tap weight”. In this implementation, there are taps for the cursors POST4 through POST13. The relatively long track phase of six (6) UI allows for complete charging of the DFE sampling caps (1021/1071) by the DAC 272.

The section 1106 shows how previous decisions from the various other DFE slices are used by the D5 slice to evaluate the DFE coefficients. The line 1110 shows the instant that the RSA for slice 5 is clocked, in order to determine the voltage at the summing node 280. Note that slice 5 does not use the most recent decisions, which are from slices 4, 3, and 2, shown as “not used” using reference numeral 1107. This relaxes the power needed to meet timing requirements in high data rate designs. These three decisions correspond to postcursors 1, 2, and 3, which are sampled in the FFE (shown using 1102), and so the entire pipelined receiver can still compensate for distortions at these cursors. Also note, slice 5 uses the decision from its own RSA, from the previous cycle (shown using reference numeral 1115), to apply the coefficient for postcursor 8. For all decisions that occurred previous to this (postcursors 9 through 13), the decision is stored in a memory element, such as a flip flop, so it will not be overwritten before slice 5 uses it. This is shown in the diagram 1100 by the boxes 1121, 1122, 1123, 1124 and 1125 at the outputs of the five decisions prior to postcursor 8. The boxes 1121, 1122, 1123, 1124 and 1125 refer to memory elements.

Each of the traces, e.g., “D0”, from FIG. 11, represents a 2-bit word which is the output decision of a slice, D0 in this example. The 2-bit decision is a PAM 4 symbol, also referred to as a PAM 4 feedback word. The MSB of that symbol will be applied to the MSB block 650 inside the DFE unit cell 1000, and the LSB of that symbol will be applied to the LSB block 600 inside the DFE unit cell 1000. The 2-bit PAM 4 decision is represented by the “PAM 4 feedback word” which is provided to the DFE clock generation logic 702 over connection 652. This decision drives either the “ck_ev0” signal or the “ck_ev1” signal of both the MSB block 650 (“ck_ev0_msb” and “ck_ev1_msb”) and the LSB block 600 (“ck_ev0_lsb” and “ck_ev1_lsb”).

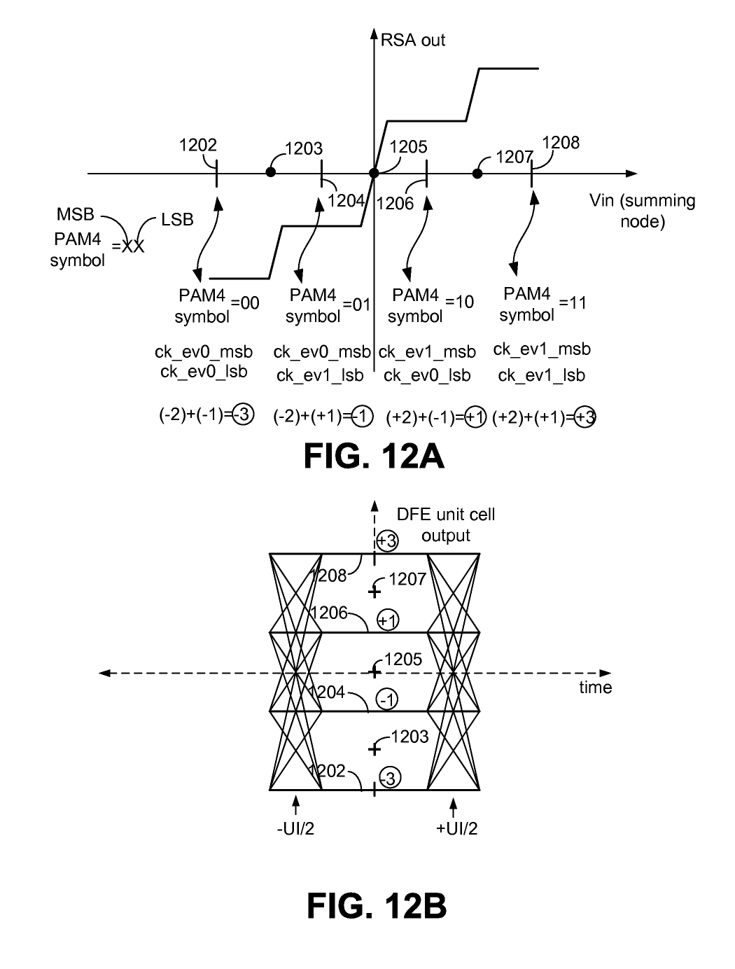

FIGS. 12A and 12B are diagrams showing the relationship between the output of the DFE unit cell of FIG. 10 and a PAM4 feedback word.

The RSA 240 uses three samplers, each with a different threshold level, to determine which of the four PAM 4 symbols to use to encode the summing node 280 with the correct voltage. The three threshold levels correspond to the three samplers and are illustrated using reference numerals 1203, 1205 and 1207. For example, if the voltage on the summing node 280 is less than the voltage associated with sampler at level 1205, but more than the voltage associated with the sampler at level 1203, then the RSA 240 will choose PAM 4 symbol 01 (voltage level 1204), which will cause any DFE unit cells that use that decision word to initiate the “ck_ev0_msb” signal and the “ck_ev1_lsb” signal. Since the circuitry associated with the MSB and LSB are sized at a 2X to 1X ratio, the total charge that the DFE unit cell capacitors contribute to the summing node 280 using the PAM 4 symbol 01 will be proportional to (−2)+(+1)=−1. In other words, the DFE coefficient, which is stored as a DAC driven voltage onto the capacitors 1021 and 1071 would be applied to the summing node 280 in factors of either −3, −1, +1, or +3, depending on the decision symbol. This results in a linear contribution by the DFE decision to the summing node 280, with a constant spacing between each adjacent symbol, as shown by levels 1202, 1204, 1206 and 1208 in FIG. 12B. This depiction is equivalent to an eye diagram of the DFE contribution from one DFE unit cell 1000, to the summing node 280. The entire y-axis would scale with the “tap weight” for that DFE unit cell, and be programmed using the DACs in 272.

Using the same hardware, and only changing registers in 256, the design can relax from receiving PAM 4 data at a given data rate, to receiving PAM 2 data at half that data rate. One simple way to configure PAM2 operation would be to disable all the LSB cells, so that only −2 and +2 feedback contributions would result from the MSB cells. Another way would be to program the DACs that drive the three RSA thresholds (274 in FIG. 2) to have the same level (e.g., the level corresponding to the point 1205). In this manner, the two possible outputs would result in −3 and +3 contributions to the summing node 722 only (PAM 2).

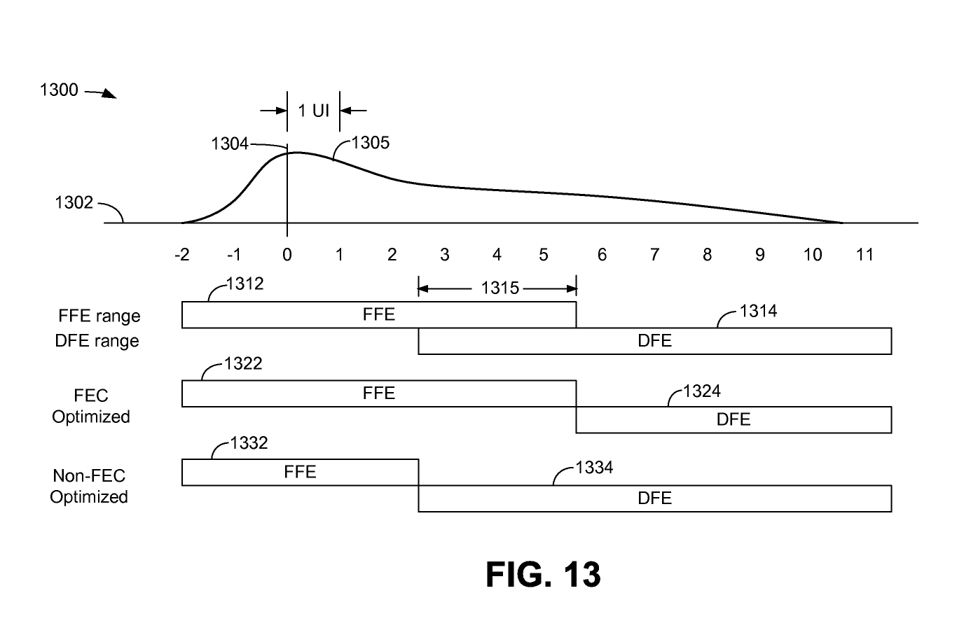

FIG. 13 is a graph 1300 showing a relationship between FFE and DFE as it relates to a communication pulse. The horizontal axis 1302 refers to time and the vertical axis 1304 refers to relative amplitude. An example pulse 1305 is shown as being sampled at a time “0.” The horizontal axis 1302 shows time increasing from “0” to the right and decreasing from “0” to the left. The units refer to system clock intervals in one (1) UI increments. The time “0” is the time that a subject cursor illustrated using the pulse 1305 is sampled. The pulse 1305 is shown from approximately −2 UI to approximately 10 UI and ideally reaches maximum amplitude at time “0.”

The range of time in UI over which the FFE and the DFE operate are shown using bars. Generally, the FFE operates linearly on both pre- and post-cursors (UIs before and after “0”), and the DFE operates non-linearly on post-cursors only. For example, the range over which the FFE may operate comprises two pre-cursors (−2 UI) to 5 post cursors (5 UI) for a total in this example of 7 UI, shown using reference numeral 1312. The range over which the DFE may operate comprises 9 post cursors for a total in this example of 9 UI, shown using reference numeral 1314. In this example, the FFE and the DFE overlap for 3 UI, shown using reference numeral 1315. The term “overlap” as used herein refers to a mode in which at least one tap of both the FFE and the DFE operate on a subject cursor or bit. The number of UI over which the FFE and the DFE operate is related to the number of “taps” for each of the FFE and the DFE, with each tap corresponding to 1 UI.

Generally, it is desirable to minimize the overlap of the operation of the FFE and the DFE, as the FFE and the DFE are beneficial for different optimization criteria. For example, in a situation in which there is forward error correction (FEC) and latency is not a primary optimization criteria, it is generally desirable to maximize the range over which the FFE operates. This is because the DFE can introduce non-linear burst errors which can make the FEC coding gain less effective than with no DFE. This situation is illustrated with bar 1322 showing the maximum number of FFE taps (in this example) and bar 1324 showing a minimized number of DFE taps.

In a situation in which there is no FEC, or its latency effects, or the signal-to-noise ratio (SNR) of the signaling medium indicates that the receiver doesn't need FEC, it is generally desirable to maximize the range over which the DFE operates. This situation is illustrated with bar 1334 showing the maximum number of DFE taps and bar 1332 showing a minimized number of FFE taps. In accordance with an embodiment of the modal PAM2/PAM4 FFE DFE receiver optimized for FEC, the number of FFE taps and the gain of each FFE tap are variable and the number of DFE taps and the gain of each DFE tap are variable, based on one or more system and channel parameters. Non-limiting examples of channel parameters are the BER of the communication channel over which the receiver 200 is communicating and the signal-to-noise ratio (SNR) of the communication channel over which the receiver 200 is communicating. Further, a variable gain element associated with each FFE tap and each DFE tap can be used to adjust, control, and vary the gain of each FFE tap and each DFE tap based at least in part on one or more of the channel parameters.

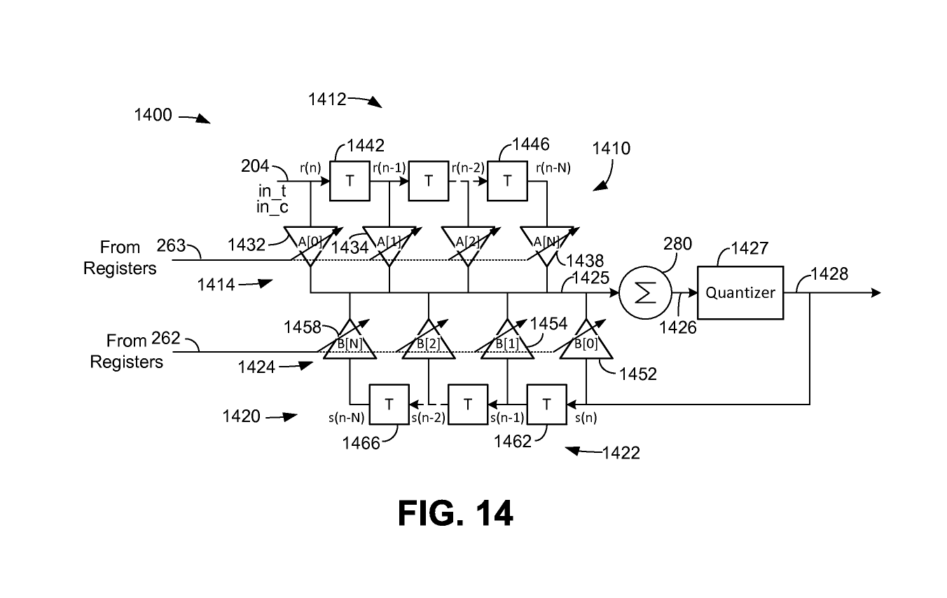

FIG. 14 is a block diagram showing an example implementation of FFE and DFE in a receiver. The block diagram 1400 illustrates a simplified FFE and DFE implementation and includes FFE section 1410 and DFE section 1420. The FFE section 1410 includes FFE taps 1412 and FFE variable gain stages 1414. Each FFE tap 1412 corresponds to one UI. The DFE section 1420 includes DFE taps 1422 and DFE variable gain stages 1424. Each DFE tap 1422 corresponds to one UI.

The selection and implementation of the FFE taps 1412 and the FFE variable gain stages 1414 are controlled by signals from the registers 256 over connection 263 (FIG. 2), under the control of the CPU 252. Similarly, the DFE taps 1422 and the DFE variable gain stages 1424 are controlled by signals from the registers 256 over connection 262 (FIG. 2), under the control of the CPU 252.

The output of the CTLE 202 is provided on connection 204 (in_t and in_c) as input signal r(n) and is provided to a first FFE variable gain stage 1432. The input signal on connection 204 then traverses FFE tap 1442, which creates a one (1) UI delay, so that the input signal r(n−1) can be provided to FFE variable gain stage 1434. The input signal is processed this way until it reaches the Nth FFE tap 1446 after which it is processed by FFE variable gain stage 1438. The output of each FFE variable gain stage 1414 is provided over connection 1425 to the summing node 280.

The output of the summing node 280 is provided over connection 1426 to a quantizer 1427. The quantizer 1427 processes the analog signal on connection 1426 and generates a digital one (1) bit output signal, s(n), on connection 1428.

The digital one (1) bit output signal on connection 1428 is provided to a first DFE variable gain stage 1452. The input signal on connection 1428 then traverses DFE tap 1462, which creates a one (1) UI delay, so that the input signal s(n−1) can be provided to DFE variable gain stage 1454. The input signal is processed this way until it reaches the Nth DFE tap 1466 after which it is processed by DFE variable gain stage 1458. The output of each DFE stage 1424 is provided over connection 1425 to the summing node 280.

The summing node 280 combines the outputs of the FFE variable gain stages 1414 and the DFE variable gain stages 1424 to generate an equalized signal on connection 1425.

In an embodiment, the amount of FFE and DFE to apply to a received signal can be determined apriori based on known system parameters. When implemented in this manner, a single receiver implementation can be used for multiple communication system applications. For example, for many applications, the communication standard being implemented will either be able to tolerate the latency induced by forward error correction (FEC), or it will not. In other applications, the communication standard will be known to have a worst case BER or SNR, which is typically worse than what is acceptable without FEC, and will then default to always having FEC enabled. Typically, if FEC is utilized in the communication system, it is generally preferable to minimize the number of DFE taps, and thus maximize the number of FFE taps. This situation is illustrated in FIG. 13 using the FFE bar 1322 and the DFE bar 1324.

In alternative embodiments, such as when the ratio of the FFE/DFE cannot be determined apriori, or where optimal receiver performance may vary based on configuration or varying receiver parameters, one or more of the channel parameters or the receiver parameters may be used as a metric for determining the optimal FFE and DFE settings. For example, the bit error rate (BER) of the receiver can be utilized as a metric for determining the optimal FFE and DFE settings.

In an implementation in which non-overlapping FFE/DFE settings are being utilized, a least mean squares (LMS) algorithm can be utilized to optimize each of the FFE and DFE configurations. For example, two configurations cases A: {FFE=[1:3], DFE[4:10]} and B: {FFE=[1:4],DFE[5:10]} can be optimized separately, and then the system's BER can be measured (with or without FEC, depending if FEC is implemented) to determine the optimal FFE and DFE settings. The numbers in the brackets refer to the UIs over with the FFE and the DFE operate.

In other embodiments it may be beneficial to overlap the FFE and the DFE taps so that both FFE and DFE operate on at least one cursor. In an embodiment, an overlapped optimal setting of the FFE and DFE can be determined by utilizing a BER metric to optimize concurrent FFE/DFE tap settings. One way to accomplish this is to sweep both the FFE taps and the DFE taps through their full cross-product of settings, to identify an ideal setting via measuring a BER metric. Alternatively, a gradient search of successive approximation along the path of steepest descent can be utilized to optimize the tuning time.

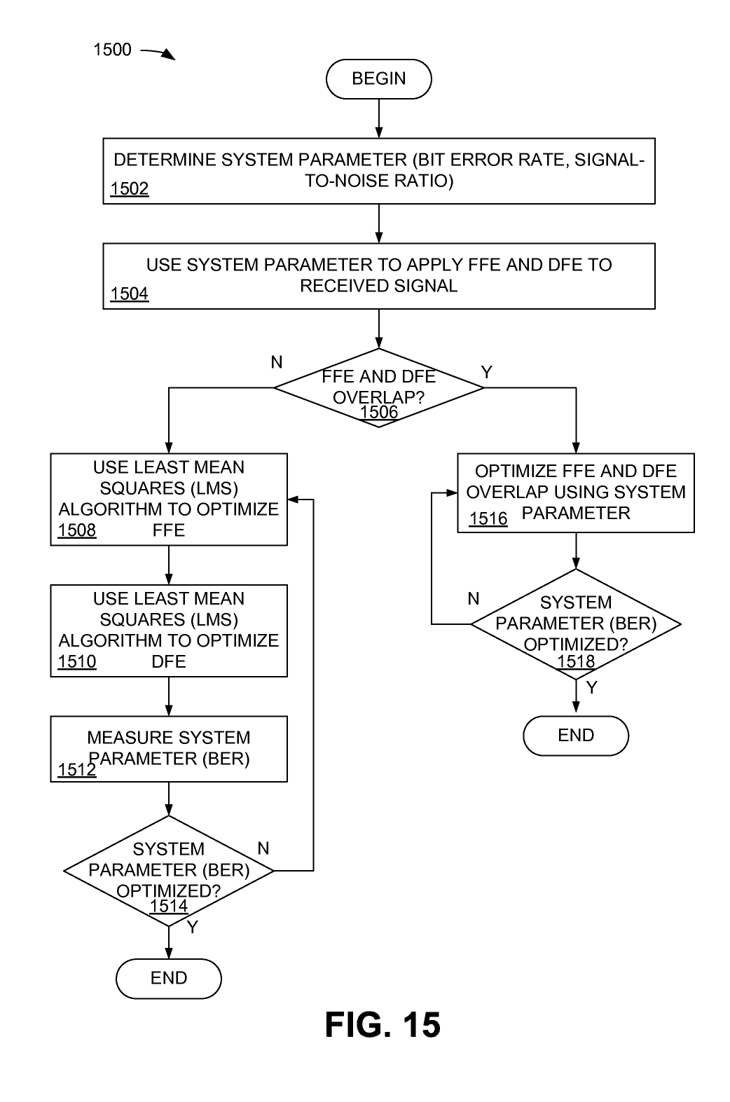

FIG. 15 is a flow chart illustrating an embodiment of a method for operating a pipelined programmable receiver having feed forward equalizer (FFE) and decision feedback equalizer (DFE) optimized for forward error correction (FEC) bit error rate (BER) performance.

In block 1502, one or more receiver or system parameters are determined. For example, the bit error rate (BER) of the communication channel can be determined by the receiver using one or more of the methods described above in FIG. 2. Other examples of system parameters include signal-to-noise ratio (SNR) or any other measurable system or receiver parameter.

In block 1504, these parameters are applied to adjustably control the number and operation of FFE taps and DFE taps in the receiver 200.

In block 1506, it is determined whether it is desirable to have overlapping FFE and DFE.

If it is determined in block 1506 that FFE and DFE overlap is not desired, then in block 1508, the FFE is independently optimized. As an example, the FFE can be optimized using a least mean squares (LMS) or other known methodology for optimizing FFE performance.

In block 1510, the DFE is independently optimized. As an example, the DFE can be optimized using a least mean squares (LMS) or other known methodology for optimizing DFE performance.

In block 1512, a system parameter is measured. For example, the BER of the communication channel and the receiver can be measured.

In block 1514, it is determined whether the system parameter is optimized, which is a direct reflection on whether the settings of the FFE and the DFE are optimized. If it is determined that the system parameter is not optimized, then the process returns to block 1508, and the optimization process repeats. If it is determined that the system parameter is optimized, then the process ends.

If it is determined in block 1506 that FFE and DFE overlap is desired, then in block 1516, the FFE and the DFE are optimized together using a system parameter. In an embodiment, the BER of the communication channel and the receiver can be measured and used as an indicator of DFE and FFE optimization.

In block 1518, it is determined whether the system parameter is optimized, which is a direct reflection on whether the settings of the FFE and the DFE are optimized. If it is determined that the system parameter is not optimized, then the process returns to block 1516, and the optimization process repeats. If it is determined that the system parameter is optimized, then the process ends.

This disclosure describes the invention in detail using illustrative embodiments. However, it is to be understood that the invention defined by the appended claims is not limited to the precise embodiments described.

1. A pipelined receiver, comprising:
a programmable feed forward equalizer (FFE);
a programmable decision feedback equalizer (DFE); and
a logic element configured to control at least one of a number of FFE taps and DFE taps to apply to a received signal based on at least one channel parameter.

2. The pipelined receiver of claim 1, wherein the channel parameter is bit error rate (BER).

3. The pipelined receiver of claim 1, wherein the channel parameter is signal-to-noise ratio (SNR).

4. The pipelined receiver claim 1, further comprising a forward error correction (FEC) element, wherein the at least one of a number of FFE taps and DFE taps is controlled such that the available FFE is optimized.

5. The pipelined receiver of claim 1, wherein the at least one of a number of FFE taps and DFE taps is controlled such that the function of the FFE and the DFE overlap.

6. The pipelined receiver of claim 1, wherein a number of FFE taps, a gain applied to each FFE tap, a number of DFE taps, and a gain applied to each DFE tap are determined based on the at least one channel parameter.

7. The pipelined receiver of claim 5, wherein a number of FFE taps, a gain applied to each FFE tap, a number of DFE taps, and a gain applied to each DFE tap are determined based on the at least one channel parameter and are simultaneously applied to the at least one bit.

8. A method for processing a signal in a pipelined receiver, comprising:
providing the receiver with a programmable feed forward equalizer (FFE);
providing a programmable decision feedback equalizer (DFE); and
controlling at least one of a number of FFE taps and DFE taps applied to a received signal based on at least one channel parameter.

9. The method of claim 8, wherein the channel parameter is bit error rate (BER).

10. The method of claim 8, wherein the channel parameter is signal-to-noise ratio (SNR).

11. The method of claim 8, further comprising:
providing a forward error correction (FEC) element; and
controlling the at least one of a number of FFE taps and DFE taps such that the available FFE is optimized.

12. The method of claim 8, further comprising controlling the at least one of a number of FFE taps and DFE taps such that the function of the FFE and the DFE overlap.

13. The method of claim 8, wherein a number of FFE taps, a gain applied to each FFE tap, a number of DFE taps, and a gain applied to each DFE tap are determined based on the at least one channel parameter.

14. The method of claim 12, wherein a number of FFE taps, a gain applied to each FFE tap, a number of DFE taps, and a gain applied to each DFE tap are determined based on the at least one channel parameter and are simultaneously applied to the at least one bit.

15. A receiver system, comprising:
a plurality of parallel processing stages configured to receive an output of a continuous time linear equalizer (CTLE);
a programmable feed forward equalizer (FFE);
a programmable decision feedback equalizer (DFE); and
a logic element configured to control at least one of a number of FFE taps and DFE taps to apply to a received signal based on at least one channel parameter.

16. The receiver system of claim 15, wherein the channel parameter is bit error rate (BER).

17. The receiver system of claim 15, wherein the channel parameter is signal-to-noise ratio (SNR).

18. The receiver system claim 15, further comprising a forward error correction (FEC) element, wherein the at least one of number of FFE taps and DFE taps is controlled such that the available FFE is optimized.

19. The receiver system of claim 15, wherein the at least one of a number of FFE taps and DFE to taps is controlled such that the function of the FFE and the DFE overlap.

20. The receiver system of claim 15, wherein a number of FFE taps, a gain applied to each FFE tap, a number of DFE taps, and a gain applied to each DFE tap are determined based on the at least one channel parameter.

21. The receiver system of claim 19, wherein a number of FFE taps, a gain applied to each FFE tap, a number of DFE taps, and a gain applied to each DFE tap are determined based on the at least one channel parameter and are simultaneously applied to the at least one bit.
